(19) United States
(12) Patent Application Publication
(10) Pub. No.: US 2008/0118331 A1
(43) Pub. Date: May 22, 2008

(54) Fastening Of Boards Or Slats Made Of Wood Or Of Wood Materials To A Metallic Substructure By Means Of Screws

(75) Inventor: Erich Palm, Au (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: SFS INTEC HOLDING AG, Heerbrugg (CH)

(21) Appl. No.: 11/720,228

(22) PCT Filed: Jan. 17, 2006
(86) PCT No.: PCT/EP06/50247

§ 371 Date: May 25, 2007

(30) Foreign Application Priority Data
Jan. 25, 2005 (DE) 102005003472.1

(51) Int. Cl. F16B 25/10; F16B 5/02

(52) U.S. Cl. 411/387.4

(57) ABSTRACT

A connection arrangement for boards, panels or slats (1) made from wood pr of wood materials to a metallic substructure (2) is provided. The screws (3) that are used include a screw head (4) and a shank (6) provided, at least over a portion of its length, with a thread (5). The screw (3) is screwed in from the side of the metallic substructure (2) and engages, via the shank (6) provided with the thread (5), inside the boards, panels or slats (1) made of wood or of wood materials. An essentially non-threaded shank section (7) is provided between the screw head (4) and a beginning of the thread (5) on the shank (6). The length of this non-threaded section corresponds, at least approximately, to a thickness (D) of the metallic substructure (2) through which the screw (3) is to pass. The outside diameter (A) of the thread (5) is made larger than the diameter (U) of a bore (8) made in the metallic substructure (2).

### BACKGROUND

The invention relates to the fastening of boards, panels, or slats made of wood or wood materials to a metallic substructure by means of screws, which comprise a screw head and a shank provided with a thread over at least a part of its length.

When fastening boards, panels, or slats, generally screws are used, which are guided through the parts made from wood or wood material and which engage a metallic substructure by way of a threaded connection. It is also known to provide penetrating bores, through which then screws and nuts are used for a mutual fastening. Furthermore, it is also known to use rivets for such fastening. In all these embodiments, at the top or the outside of the boards, panels or slats, the screw heads or rivet heads are visible and additionally, in particular in case of screws, there is the risk of loosening, namely particularly when the fastening is subject to vibration, in particular.

### SUMMARY

Therefore, the object of the present invention is to create a fastening of the type mentioned at the outset, in which the screw heads are not visible at the outside of the board, panel, or slat and which practically cannot be loosened independently, even under constant vibration.

This is achieved according to the invention in that the screw is screwed in from the side of the metal substructure and engages with its shank, provided with a thread, the boards, panels, or slats made from wood or wood material such that an essentially thread-free shank section is provided between the screw head and the beginning of the thread, with its length being at least equivalent to approximately the thickness of the metallic substructure to be penetrated by the screw, and that the exterior diameter of the thread is embodied larger than a diameter of the bore prepared in the metallic substructure.

Therefore, a screwing in of the screws from the bottom or the rear of the construction occurs. Additionally it is particularly advantageous that the screw is screwed into the metallic substructure through a bore, and thus during the screwing process is engaging a thread. As soon as the screw is screwed in completely the thread on the shank leaves the thread on the bore in the metallic substructure so that security from loosening is given. Therefore, screw can no longer be unscrewed, because the thread can no longer be inserted into the thread of the bore in the metallic substructure. Thus, a permanently secure fastening has been created. This has a particularly positive effect in the fastening of surface mountings placed onto the metallic substructure of trucks.

Even when perhaps the bore in the metallic substructure must be prefabricated, the optimum fastening is always achieved when the thread of the screw is embodied both in the metallic substructure as well as in the boards, panels, or slats in a self-forming or self-cutting manner. Therefore, an optimally fitting thread engagement is always given.

One particular embodiment provides that the shank section of the screw immediately adjacent to the screw head is embodied thread free. This represents a particularly beneficial construction variant, particularly because the screw in this section can not engage a bore thread.

Another embodiment variation provides that the diameter of the essentially thread free shank section is smaller than an exterior diameter of the thread. Thus, a compensation for motions between the different materials to be connected, metal and wood or wood material is possible. Therefore, the bore in the metallic substructure encompasses the threaded shank section with play.

In this context, one possibility comprises that the diameter of the essentially thread free shank section is essentially equivalent to a root diameter of the thread. Another variant provides that the diameter of the essentially thread free shank section is smaller than the root diameter of the thread. Therefore, there is a chance of adjustment, if necessary.

Another variant provides that the thread free or essentially thread free shank section of the screw conically tapers beginning at the bottom of the screw head towards the beginning of the thread. In this way, a centering of the shank of the screw can occur in the bore in the metallic substructure, in which said screw section contacts the bore wall in the area below the screw head.

Another possibility further provides that at one end of the screw, a boring tip is embodied. In this way, pre-drilling can be omitted in special materials of the metallic substructure and also of the boards, panels, or slats because the screw itself can bore the holes and cut the thread.

It may further be provided that the thread of the screw, in the finished state, is entirely guided out of the metallic substructure and exclusively engages the boards, panels, or slats, then it is even ensured that uneven boards, panels, or slats can still be pulled against the metallic substructure. The screw can therefore still be screwed in the metallic substructure until the parts to be screwed together are contacting solidly.

Another embodiment variation provides for the thread to be embodied with two or more threads on the shank of the screw. In this manner, a faster setting of the screw is possible and additionally any security from loosening is increased because then two or three threads, off-set in their angle in reference to each other, have to find their threads in the bore in the metallic substructure.

In order to allow an easier screwing of the screw, in particular in the area of the boards, panels, or slats made from wood or wood material, it is suggested that at least the section of the shank of the screw provided with a thread is coated with a gliding lubricant.

One embodiment provides for the screw head of the screw to be provided as double-frustum shaped or convex. Therefore, only a relatively small contact area of the screw head is given on the metallic substructure so that a compensation for motion is facilitated.

In one advantageous embodiment it is suggested that the bore in the metallic substructure is prefabricated. This allows a faster and also easier placing of the screw.

With regard to assembly, an improvement results when a hole for accepting the shank of the screw is predrilled into the boards, panels, or slats. This way, the screwing torque can be essentially reduced even further, which is particularly advantageous for the use in particularly hard wood materials. In this context it is advantageous for the diameter of the predrilled hole in the boards, panels, or slats to essentially be equivalent to the core diameter of the shank of the screw provided with a thread.

### BRIEF DESCRIPTION OF THE DRAWINGS

In the following description additional features of the invention and particular advantages are explained in greater detail using the drawing. Shown are:

FIG. 1: a cross-sectional view through a metallic substructure and a board, panels, or slat to be connected thereto, with the connection occurring by way of a screw;

FIG. 2: a cross-sectional view similar to FIG. 1, however, with a different screw being inserted.

### DETAILED DESCRIPTION OF THE PREFERRED EMBODIMENTS

The fastening of boards, panels 1, or slats made from wood or wood material to a metallic substructure occurs here by way of screws 3, which comprise a screw head 4 and a shank 6, provided with a thread 5 over at least part of its length. Such a fastening can be inserted at all places, at which parts made from wood or wood material shall be connected to a metallic substructure. This particularly relates to the loading surfaces of trucks or trailers, where relatively thick boards or panels, generally made from hard wood materials (e.g., plywood, compressed wood, particle boards) shall be fastened on the metallic substructure (body made from metal carriers).

According to the invention, now the screw 3 is screwed in from the side of the metallic substructure 2 and engages with its shank 6, provided with a thread 5, the boards, panels, or slats made from wood or wood material. An essentially thread free shank section 7 is provided on the shank 6 between the screw head 4 and the beginning of the thread 5, its length being at least equivalent to approximately the thickness D of the metallic substructure 2 to be penetrated by the screw 3. The exterior diameter A of the thread 5 is embodied larger than the diameter U in a bore 8 prepared in the metallic substructure 2.

The thread 5 of the screw 3 can therefore create a counter-thread by way of self forming or self cutting both in the metallic substructure 2 as well as in the boards, panels, or slats.

The shank section 7 of the screw 3 immediately adjacent to the screw head 4 is advantageously embodied thread free. However, it is also possible to provide another threaded section, here, with a considerably smaller exterior diameter than the exterior diameter A of the thread 5. This shank section 7 may also be provided with a different surface structure, for example ribs, knurls, or the like may be provided extending parallel or circumferential in reference to the axis.

Advantageously, the diameter S of the essentially thread free shank section 7 is smaller than the exterior diameter A of the thread 5. It is also possible for the diameter S of the essentially thread free shank section 7 to be essentially equivalent to the root diameter K of the thread 5. In another embodiment, the diameter S of the essentially thread free shank section 7 is smaller than the root diameter K of the thread 5.

In the embodiment shown in the drawings, it is provided that the thread free or essentially thread free shank section 7 of the screw 3 conically tapers beginning at the bottom of the screw head 4 towards the beginning of the thread 5.

If the bores in the panel 1 and perhaps also in the metallic substructure 2 are created by the screw 3 itself a boring tip 9 is formed at one end of the screw 3. This may be a drilling part or an inserted drilling plate, with the drilling tip 9 or the drilling part or the drilling plate being possibly produced from a material different from the other material of the screw, if necessary.

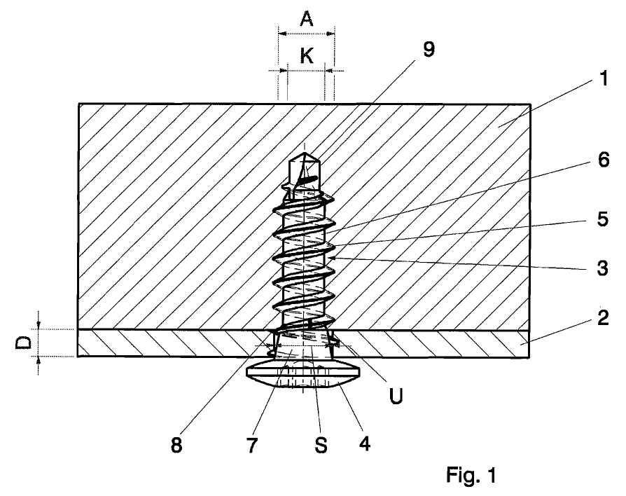

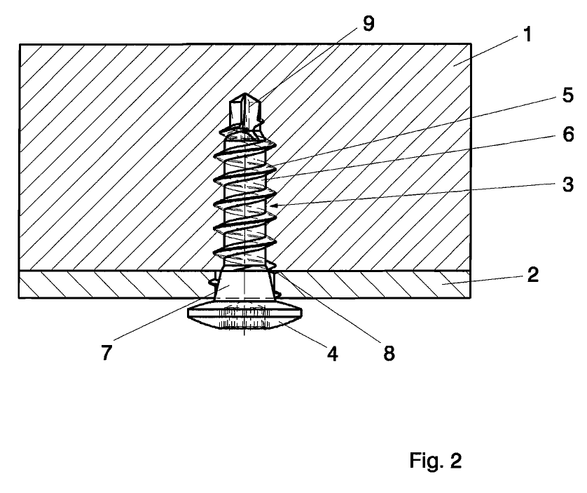

In the embodiment according to FIG. 1, in the completely inserted state, the beginning of the thread 5 also engages to a slight extent the metallic substructure 2. However, when as discernible in the embodiment according to FIG. 2, the thread 5 of the screw 3 is entirely moved out of the metallic substructure 2 in the inserted state, the screw 3 can still be rotated in reference to the substructure 2 to a slight extent and thus screwed even further into the plate 3 so that the plates 1 and the substructure 2 can be pressed tightly against each other.

According to another embodiment, it the thread 5 on the shank 6 of the screw 3 can be embodied with two or more threads. This way a fast placement of the screw 3 would be possible as well as an even improved protection from reversed screwing, particularly since all thread exits have to be guided back into the threads produced in the substructure 2.

Particularly when screwed into wood or wood material, the screwing torque for the screw 3 can be further improved when at least the section of the shank 6 of the screw 3 provided with a thread 5 is coated with a gliding lubricant. In the exemplary embodiments shown, it is provided for the screw head 4 of the screw 3 to be formed double-frustum shaped or convex. Within the scope of the invention any other arbitrary form may also be used for the screw head. For example, a multi-faceted head is possible, having exterior or interior driving flats. In the positioned state of the screw, the screw head is no longer visible from the outside of the panel or the like so that a particularly beautiful shape is not necessary.

The bore 8 is beneficially prefabricated in the metallic substructure 2. Additionally, it is further possible to pre-drill a hole for accepting the shank 6 of the screw 3 in the boards, panel 1, or slats. Here, it is advantageous when the diameter of the predrilled hole in the boards, plates 1, or slats is essentially equivalent to the core diameter K of the shank 6 of the screw 3 provided with a thread 5.

The present invention provides for an optimum fastening between boards, panels 1 or slats made from wood or wood material to a metallic substructure 2, because it provides the possibility to cause the fastening from the side of the metallic substructure 2. In this manner, a secure fastening is created, with additionally the fastening not being loosenable independently even under intense oscillation or constantly altering stress.

1. A connection of boards, panels, or slats made from wood or wood material to a metallic substructure via screws, which comprise a screw head and a shank provided with a thread over at least part of a length thereof, the screw (3) is inserted from a side of the metallic substructure (2) and engages the boards, panels (1), or slats made from the wood or wood material with the shank (6), provided with the thread (5), and a shank section (7) is provided between the screw head (4) and a beginning of the thread (5) that is essentially free from threads, with a length of the thread free shank section being at least approximately equivalent to a thickness (D) of the metallic substructure (2) to be penetrated and an exterior diameter (A) of the thread (5) is larger than a diameter (U) of a bore (8) prepared in the metallic substructure (2).

2. The connection according to claim 1, wherein the thread (5) of the screw (3) is a self-cutting and/or self-forming thread for forming a counter-thread both in the metallic substructure (2) as well as in the boards, panels (1) or slats.

3. The connection according to claim 1, wherein the shank section (7) of the screw (3) immediately adjacent to the screw head (4) is thread free.

4. The connection according to claim 1, wherein, a diameter (S) of the essentially thread free shank section (7) is smaller than the exterior diameter (A) of the thread (5).

5. The connection according to claim 1, wherein the diameter (S) of the essentially thread free shank section (7) is essentially equivalent to a root diameter (K) of the thread (5).

6. The connection according to claim 1, wherein the diameter (S) of the essentially thread free shank section (7) is smaller than a root diameter (K) of the thread (5).

7. The connection according to claim 1, wherein the essentially thread free shank section (7) of the screw (3) conically tapers from a bottom of the screw head (4) towards a beginning of the thread (5).

8. The connection according to claim 2, wherein a boring tip (9) is located at one end of the screw (3).

9. The connection according to claim 1, wherein the thread (5) of the screw (3) in an inserted state is entirely guided out of the metallic substructure (2) and engages exclusively the boards, panels (1) or slats.

10. The connection according to claim 1, wherein the thread (5) on the shank (6) of the screw (3) includes two or more threads.

11. The connection according to claim 1, wherein at least a section of the shank (6) of the screw (3) provided with the thread (5) is coated with a gliding lubricant.

12. The connection according to claim 1, wherein the screw head (4) of the screw (3) is embodied double-frustum shaped or convex.

13. The connection according to claim 1, wherein the bore (8) in the metallic substructure is prefabricated (2).

14. The connection according to claim 13, wherein a hole for acceptance of the shank (6) of the screw (3) is predrilled in the boards, panels (1), or slats.

15. The connection according to claim 14, wherein a diameter of the predrilled hole in the boards, panels (1), or slats is essentially equivalent to a core diameter (K) of the shank (6) of the screw (3) provided with threads.
